(19) United States
(12) Patent Application Publication
(10) Pub. No.: US 2012/0301770 A1
(43) Pub. Date: Nov. 29, 2012

(54) ELECTROCHEMICAL CELL

(75) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/504,926

(22) PCT Filed: Oct. 22, 2010
(86) PCT No.: PCT/EP2010/006476

§ 371 Date: Aug. 13, 2012

(30) Foreign Application Priority Data
Oct. 29, 2009 (DE) 10 2009 051 213.6

(51) Int. Cl. H01M 10/50

(52) U.S. Cl. 429/120

(57) ABSTRACT

An electrochemical cell comprises an electrode stack, a jacket which encloses the electrode stack to at least some extent, and at least one current collector which extends away from the jacket and is in current-carrying contact with at least parts of the electrode stack. A hook and loop part of a hook and loop connecting device is attached to the electrochemical cell, said hook and loop part of the hook and loop connecting device being configured by a plurality of metal hook and loop elements, especially by metal hooks or metal loops.

### CROSS-REFERENCE TO RELATED APPLICATIONS

This application is a national stage application under 35 U.S.C. §371 of International Application No. PCT/EP2010/006476, filed Oct. 22, 2010 and published as WO 2011/050931, which claims priority to German patent application number DE 10 2009 051 213.6, filed Oct. 29, 2009, the entirety of each of which is hereby incorporated herein by reference.

### SUMMARY

The present invention relates to an electrochemical cell, particularly for use in an electrically powered vehicle.

Patent number WO 96/29749 A1 discloses a method and structure for attaching a battery to an electrical device. In this way, a battery is attached to the electrical device with a hook and loop fastener. The elements of the hook and loop fastener may be produced from an electrically conductive material.

Patent number WO 2009/089881 A1 discloses a method for producing closure elements for metal touch and close fasteners. In this case, bending operations are carried out in which hooking elements are raised out of the plane of a support element and bent until into a hooked shape.

Based on the above, the object of the present invention is to provide an improved electrochemical cell.

This object is solved with an electrochemical cell that comprises an electrode stack, a jacket which at least partially encloses the electrode stack, at least one current collector that extends away from the jacket and is in current-carrying contact with at least parts of the electrode stack, wherein a hook and loop part of a hook and loop connecting device is attached to the electrochemical cell, characterized in that the hook and loop part of the hook and loop connecting device is configured by a plurality of metal hook and loop elements, particularly by metal hooks or metal loops.

For the purposes of the present invention, an electrochemical cell is understood to mean a device that also serves to store chemical energy and emit electrical energy. To this end, the electrochemical cell may include at least one electrode stack that is isolated from the environment in largely gas- and liquid-impermeable manner by a jacket. The electrochemical cell may also be designed such that it collects electrical energy during charging. In this case, it is also called a secondary cell or a rechargeable battery. The term electrode stack also refers to electrode coils.

In this context, the term current collector refers to an element that is produced from a conductive material. It is used to conduct current between two points that are geometrically separate from one another. In the present case, a current collector may be connected to an electrode stack. In particular, the current collector is connected with all electrodes of the same type in an electrode stack, that is to say either with the cathodes or with the anodes. It is self-evident that a current collector is not connected to the cathodes and the anodes of an electrode stack at the same time, since this would result in a short circuit. But a current collector may be connected to different electrodes from different electrode stacks, for example in a series connection of the two electrode stacks. At least one current collector preferably protrudes out of a jacket of an electrochemical cell and may thus serve to connect the electrochemical cell with the outside. The current collector may be constructed integrally with one or more electrodes or it may be constructed generally in several parts. The fact that the current collector is particularly not coated with active electrode material may be considered to represent delimitation between the current collector and the electrode.

In the context of the present invention, the term jacket is understood to mean an at least partial delimitation that isolates at least one electrode stack from the outside. The jacket is preferably impermeable to gases and liquids, so that it is not possible to material to be exchanged with the environment. The electrode stacks are arranged inside the jacket. At least one current collector, particularly two current collectors protrude from the jacket and serve to connect the electrode stacks. The current collectors protruding to the outside preferably represent the positive terminal and the negative terminal of the electrochemical cell. However, multiple current collectors may protrude from the casing, particularly two or four current collectors. In this case, if the battery cell comprises two electrode stacks that are connected to one another in series, electrodes of different electrode stacks are connected to one another.

Hook and loop fasteners usually comprise two hook and loop parts that are constructed so as to be detachable from one another. Each hook and loop part is formed by one or more hook and loop elements, each of which is designed to cooperate with a hook and loop element on the other hook and loop part in the fastening device, and is able to be attached detachably therewith. In this way, form-fitting connections may be created between the two hook and loop parts, which are preferably detachable due to a certain elastic pliability on the part of the hook and loop elements. The hook and loop parts may each be affixed permanently to a component that is to be attached detachably to another component. The other component is then connected permanently to the other hook and loop part of the hook and loop connecting device.

The use of metal hook and loop elements provides the capability to connect electrochemical cells with other components, particularly other electrochemical cells, heat conducting strips or housing parts. However, it also enables the creation of improved contact between a current collector of the electrochemical cell and an element intended to contact the cell, for example a current collector belonging to another electrochemical cell. The metal hook and loop fastening device may be characterized by high retention forces and high resistance to thermal and chemical factors. Moreover, the metal hook and loop connection device may also create an electrically conductive connection.

One hook and loop part of the hook and loop fastening device is preferably attached to a jacket of the electrochemical cell. In particular, the hook and loop part of the hook and loop fastening device may be constructed integrally with the jacket of the electrochemical cell. In this way, it is possible to form a simple attachment between the jacket of the electrochemical cell and another component. Particularly if the hook and loop part of the hook and loop fastening device is constructed integrally with hook and loop parts of the electrochemical cell, additional measures for attaching to the other component may then be dispensed with.

One hook and loop part of the hook and loop fastening device is preferably attached to a current collector. This may preferably be constructed integrally with a current collector of the electrochemical cell. It is also advantageous if multiple current collectors, particularly both current collectors of an electrochemical cell, are equipped with a hook and loop part of a hook and loop fastening device. The hook and loop fastening device, which is attached at least partially to a current collector, may be used to provide a simple contact between the current collectors and an element to be connected. Particularly if the current collectors are constructed integrally with the hook and loop part of a hook and loop fastening device, the current collector may also be manufactured easily. A separate means for attaching the hook and loop part of the hook and loop fastening device to the current collector may then be dispensed with.

A hook and loop part of a hook and loop fastening device may preferably be formed by cutouts, particularly on the current collector or on the jacket. In this way, an integral construction of the current collector with the hook and loop part of the hook and loop fastening device may be constructed particularly easily.

Temperature control elements, particularly one or more condensing coils or one or more cooling mats are preferably arranged in spaces that are formed between hook and loop elements of a hook and loop fastening device. The space between the hook and loop elements may be used to accommodate the temperature control elements, thereby enabling a particularly compact construction. In particular, this area is well suited to provide good heat dissipation from the electrochemical cell particularly due to the large surface area of the hook and loop elements.

The present invention further relates to a battery arrangement having at least one, particularly two or more electrochemical cells of the type described in the foregoing.

In this context, preferably at least two electrochemical cells are attached to each other via a hook and loop fastening device. In particular, two electrochemical cells are attached to one another exclusively by means of a hook and loop fastening device. In this away, a lightweight and in particular detachable connection may be created between two electrochemical cells. It may be noted that the advantages of the hook and loop fastening device described previously in the context of an electrochemical cell also equally here.

In a preferred embodiment of the present invention, at least one heat conducting strip is provided and is connected to an electrochemical call via a hook and loop fastening device. The heat conducting strip is preferably made from a metallic material. The heat conducting strip is preferably connected to a first electrochemical cell by means of a first hook and loop fastening device, and to a second electrochemical cell by means of a second hook and loop fastening device. In this way, it may particularly be provided that the heat conducting strip is arranged between the first and second electrochemical cells. The heat conducting strip may be fixed in place solely by means of the hook and loop fastening device, that is to say particularly that no additional fastening means is provided for securing the heat conducting strip.

Hook and loop elements of a hook and loop fastening device may preferably be formed by cutouts on the heat conducting strip. Hook and loop elements of a first hook and loop fastening device may preferably be formed by cutouts on the heat conducting strip in a first direction, and hook and loop elements of a second hook and loop fastening device may be formed on the heat conducting strip by cutouts in a second direction. The first and second directions are preferably aligned oppositely to one another. Alternatively or in combination therewith, both directions may be aligned perpendicularly to a planar extension of the heat conducting strip. In this way, a simple, in particular single-part construction of hook and loop parts of two hook and loop fastening devices may be produced on the heat conducting strip.

Further advantages, features and application possibilities of the present invention will be apparent from the following description in conjunction with drawing. In the drawing:

### BRIEF DESCRIPTION OF THE DRAWINGS

FIG. 1 shows a first embodiment of a battery arrangement according to the present invention.

FIG. 2 shows a second embodiment of a battery arrangement according to the present invention.

FIG. 3 shows a third embodiment of a battery arrangement according to the present invention.

FIG. 4 shows a hook and loop fastening device for a battery arrangement according to the present invention.

FIG. 5 shows a heat conducting strip with hook and loop parts belonging to two hook and loop fastening devices.

### DETAILED DESCRIPTION

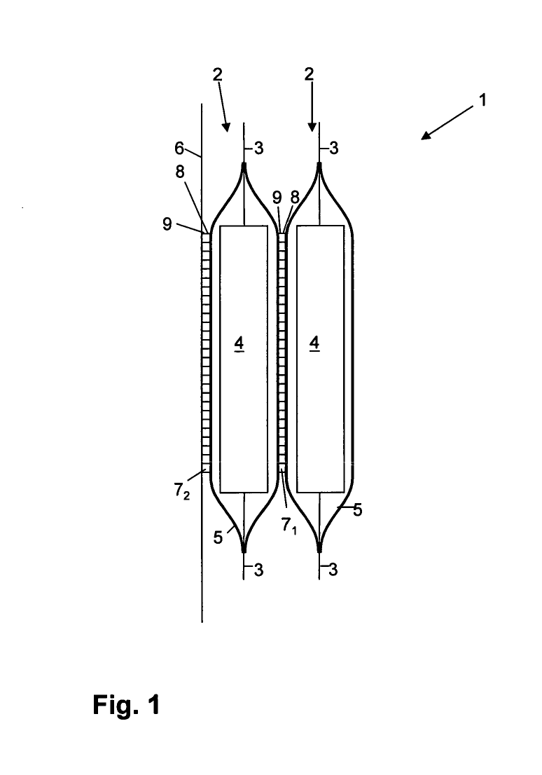

FIG. 1 shows a cross section through a battery arrangement 1 according to the present invention. Battery arrangement 1 comprises a plurality of electrochemical cells 2, of which only two are represented. Multiple electrochemical cells 2 may also be provided. Electrochemical cells 2 comprise an electrode stack 4, which is insulated in gas- and liquid-impermeable manner by a jacket 5. Current collectors 3 protrude from jacket 5 on opposite sides of the jacket 5 and each is in electrical contact with electrode stack 4.

It should be noted that the two electrochemical cells 2 in the drawing are in contact with one another. In this context, a first hook and loop fastening device 7₁ is provided between two contact surfaces of electrochemical cell 2 and serves to provide a secure but easily detachable connection between jackets 5 of the electrochemical cells.

First hook and loop fastening device 7₁ has two hook and loop parts, in which one hook and loop part, which is formed by a plurality of hooks 8, is attached to the jacked of the one electrochemical call, and the other hook and loop part of hook and loop fastening device 7₁, which is formed by a plurality of loops, is attached to jacket 5 of the other electrochemical cell 2. The two hook and loop parts of hook and loop fastening device 7 may be brought into contact with one another. In this way, hooks 8 and loops 9 may engage with each other.

A housing wall 6 is indicated schematically on the left side of the electrochemical cell 2 on the left in FIG. 1. A second hook and loop fastening device 7₂ is arranged between jacket 5 of the electrochemical cell 2 on the left and housing wall 6, and this is largely the same as the hook and loop fastening device 7₁ described previously between the two electrochemical cells 2.

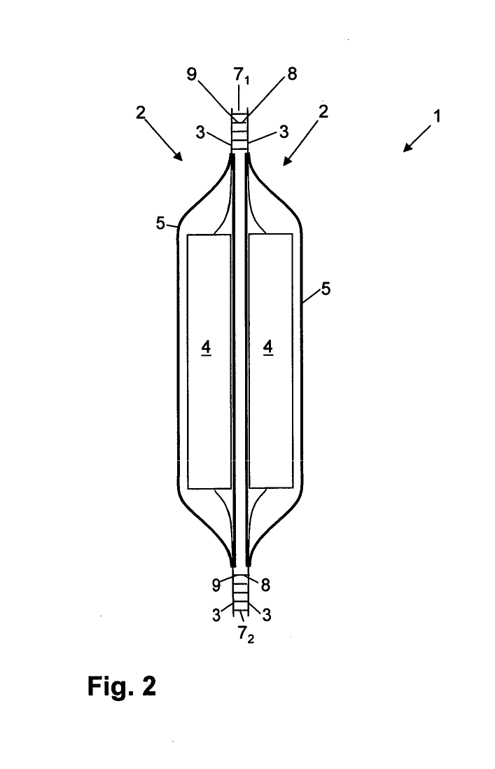

FIG. 2 shows a further embodiment of the present invention, which is largely similar to the first embodiment. Only the differences between the two will be explained in the following.

Current collectors 3 of electrochemical cell 2 are connected to one another. One hook and loop fastening device 7 is provided between each of the current collectors 3, so that current collectors 3 are attached to one another firmly but detachably. In this context, hooks 8 are formed on one current collector 3, and these engage in loops 9, which are formed on the other current collector 3. Hooks 8 and loops 9 are each constructed integrally with the respective current collector 3 and formed by cutouts from the current collectors, each of which is construction from sheet metal. The two electrochemical cells 2 are connected to one another solely by hook and loop fastening devices 7 on current collectors 3. No other fastening means are provided. However, in a further embodiment it is possible for the two electrochemical cells 2 to be connected to one another via an additional hook and loop fastening device on the respective jackets as well, as shown in FIG. 1.

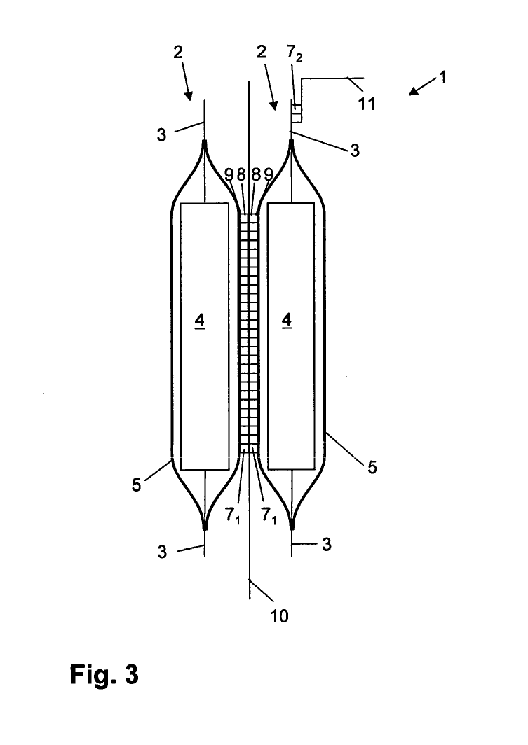

FIG. 3 shows a third embodiment of a battery arrangement 1, which is largely the same as the first embodiment. Only the differences between this and the first embodiment will be explained in the following.

Unlike battery arrangement 1 in the first embodiment, the two electrochemical cells 2 shown are not in direct contact with one another. Instead, a heat conducting strip 10 is arranged between the two electrochemical cells 2. A hook and loop fastening device 7₁ largely equivalent to the first hook and loop fastening device, as described in FIG. 1, is provided between an electrochemical cell 2 and the respective heat conducting strip 10.

A further hook and loop fastening device 7₂ is provided between a current collector 3 of the electrochemical cell 2 on the right and a contact element 11. Contact element 11 is made from sheet metal. Hook and loop fastening device 7₂ for connecting current collector 3 to contact element 11 is essentially of the same construction as the hook and loop fastening device according to the second embodiment of the battery arrangement for connecting two current collectors 3.

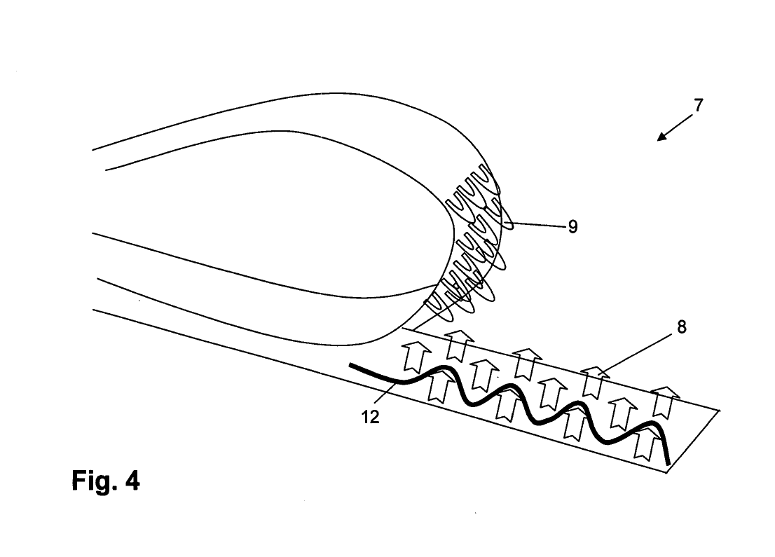

FIG. 4 shows a hook and loop fastening device that may be used in the battery arrangements according to FIGS. 1 to 3.

It is evident that hook and loop fastening device 7 comprises two hook and loop parts, one part being constructed with hooks 8 and the other part being constructed with loops 9. Hooks 8 and loops 9 may hook into each other, thereby creating a firm connection between the two hook and loop parts.

A condensing coil 12 is threaded between hooks 8. Condensing coil 12 is created as a flexible tubular element through which a cooling fluid may flow. This cooling fluid serves to conduct heat and cold to or away from 1 hook and loop fastening device 7, thereby enabling temperature control of the adjacent electrochemical cells 2.

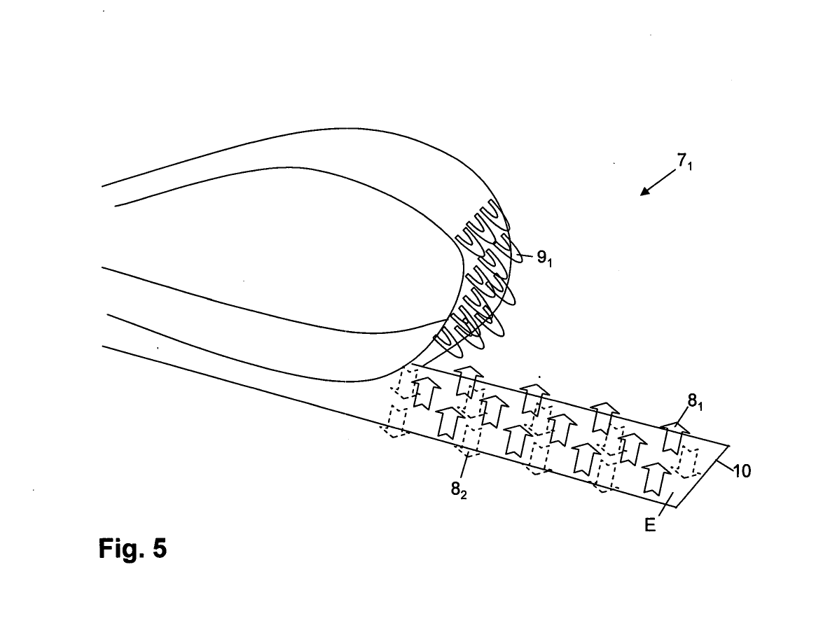

FIG. 5 shows a heat conducting strip 10. Heat conducting strip 10 is flat in construction. The heat conducting strip has first hooks 8₁ on a first side, which hooks extend from heat conducting strip 10 perpendicularly to a plane E of heat conducting strip 10. Hooks 8₁ are formed from cutouts from the metal material of the heat conducting strip 10. Second hooks 8₂ on a second side of the heat conducting strip, which are also construction from cutouts protrude from heat conducting strip 10 in the opposite direction to first hooks 8₁ Hooks 8₁ and 8₂ each represent hook and loop elements of different hook and loop fastening devices. Thus, the heat conducting strip may be connected to a first electrochemical cell via a first hook and loop fastening device with hooks 8₁; heat conducting strip 10 may be connected to a second electrochemical cell via a second hook and loop fastening device with hooks 8₂.

The hook and loop elements of the hook and loop fastening devices in all embodiments may also be formed by pairs of hooks and hooks instead of pairs of hooks and loops. The specific features of all embodiments may be used together in any combination providing no inconsistencies are created as a result of such combination.

### KEY TO FIGURES

1 Battery arrangement
2 Electrochemical cell
3 Current collector
4 Electrode stack
5 Jacket
6 Housing wall
7 Hook and loop fastening device
8 Hooks
9 Loops
10 Heat conducting strip
11 Contact element
12 Condensing coil
E Plane

1-9. (canceled)

10. An electrochemical cell, comprising:
an electrode stack;
a jacket that at least partially surrounds the electrode stack; and
at least one current collector that extends out of the jacket and is in current-carrying contact with at least parts of the electrode stack, wherein a hook and loop part of a hook and loop fastening device is attached to the electrochemical cell,
wherein the hook and loop part of the hook and loop fastening device is formed by a plurality of metal hook and loop elements, particularly metal hooks or metal loops, and
wherein spaces are formed between hook and loop elements, and a temperature control element, particularly a condensing coil or a cooling mat, is arranged in the spaces.

11. The electrochemical cell as recited in claim 10, wherein one hook and loop part of the hook and loop fastening device is attached to a jacket of the electrochemical cell, and in particular is constructed integrally with the jacket of the electrochemical cell.

12. The electrochemical cell as recited in claim 10, wherein one hook and loop part of the hook and loop fastening device is attached to a current collector, and in particular is constructed integrally with a current collector of the electrochemical cell.

13. The electrochemical cell as recited in claim 10, wherein one hook and loop part of the hook and loop fastening device is formed by cutouts on the electrochemical cell, particularly on the current collector or on the jacket.

14. A battery arrangement including at least one electrochemical cell as recited in claim 10.

15. The battery arrangement as recited in claim 14, wherein at least two electrochemical cells are attached to each other by means of a hook and loop fastening device, and in particular are attached to each other solely by means of the hook and loop fastening device.

16. The battery arrangement as recited in claim 14, wherein at least one heat conducting strip is connected to an electrochemical cell via a hook and loop fastening device, and in particular is connected to a first electrochemical cell via a first hook and loop fastening device and is connected to a second electrochemical cell via a second hook and loop fastening device.

17. The battery arrangement as recited in claim 16, wherein hook and loop elements of the first hook and loop fastening device are formed by cutouts in a first direction on the heat conducting strip, and hook and loop elements of the second hook and loop fastening device are formed by cutouts in a second direction on the heat conducting strip.
